(19) United States
(12) Patent Application Publication
(10) Pub. No.: US 2019/0291068 A1
(43) Pub. Date: Sep. 26, 2019

(54) Organogels Allowing Reduction And Control Of The Evaporation Of Volatile Organic Liquids

(71) Applicants: Centre National de la Recherche Scientifique (CNRS), Paris (FR); Universite Paul Sabatier Toulouse III, Toulouse (FR)

(72) Inventors: Alexandra Ter-Halle, Baziège (FR); Emile Perez, Colomiers (FR); Isabelle Giraud, Toulouse (FR); Sophie Franceschi, Pechbusque (FR)

(73) Assignees: Centre National de la Recherche Scientifique CNRS), Paris (FR); Universite Paul Sabatier Toulouse III, Toulouse (FF)

(21) Appl. No.: 16/317,224

(22) PCT Filed: Jul. 11, 2017
(86) PCT No.: PCT/EP2017/067446

§ 371 Date: Jan. 11, 2019

(30) Foreign Application Priority Data
Jul. 12, 2016 (FR) 1656701

(51) Int. Cl. B01J 13/00; A01N 25/04; A01N 65/28; A01N 65/22

(52) U.S. Cl. CPC B01J 13/0065; A01N 65/22; A01N 65/28; A01N 25/04

(57) ABSTRACT

The invention relates to chemical compositions in the form of an organogel, comprising a gelled organic liquid, comprising or consisting of a volatile organic liquid, and at least one resin acid. The invention also relates to a method for producing same, and the use of same to reduce and control the evaporation of the contained volatile organic liquid.

The present invention concerns chemical compositions in the organogel form comprising an organic liquid, comprising or consisting of a volatile organic liquid and at least one resin acid, the preparation method thereof and the use thereof to reduce and control the evaporation of the volatile organic liquid.

Generally, organogels are semisolid materials consisting of an organic liquid or oil, immobilized by a three-dimensional network resulting from self-assembly of a polymer or low-molecular-weight organogelator. The low-molecular-weight organogelator is a small organic molecule, or a mixture of small organic molecules, able to gel a large range of organic liquids in small proportions. Low molecular weight means a molecular weight less than 1000 g/mol, and more particularly less than 500 g/mol.

The term “organogel” means a gel in which the liquid (diluent) is an organic medium or organic solvent (as opposed to water).

The term “thermoreversible organogel” is synonymous with “physical organogel” and designates an organogel whose network structure is due to low-energy and thermally-unstable interactions such as hydrogen bonds (as opposed to solid, thermally-stable bonds, such as covalent bonds) and consequently can be transformed by heating into a free-flowing liquid. When cooled below a certain characteristic temperature (Tgel), the reformation of weak bonds reestablishes the solid gel structure.

In the sense of the present invention, the term organogelator means an organic molecule that can gel a large range of organic liquids in small proportions (see: Terech P. & Al Low molecular mass gelators of organic liquids and the properties of their gels Chemical Reviews 1997, 97, (8), p. 3133-3159 or Abdallah D. J. & Al Organogels and low molecular mass organic gelators Advanced materials 2000, 12, (7), p. 1237-1243 or Terech P. “Low molecular weight organogelators in Specialist Surfactants I. D. Robb (Ed), Blackie Academic and Professional, Glasgow. 1996, p. 208-268).

Organic liquid means a hydrophobic liquid with molecules or parts of molecules that repel water molecules to a certain degree. An organic liquid can be volatile or nonvolatile.

The organic liquid can be an organic solvent in the chemical sense of the term. The term “organic solvent” refers to solvents that are organic compounds containing carbon atoms. Solvents dissolve reactants and bring the reactants into contact. They do not react chemically with the dissolved compound. Solvents can also be used to extract soluble compounds from a mixture.

In the rest of this description, the term organic liquid will be used to encompass the functional concept of organic solvent.

Volatility means the capacity of a substance, generally liquid, at room temperature (around 20° C.) and atmospheric pressure (approximately 760 mmHg) to vaporize. Volatility may be defined as the ratio of the molar fraction of the gas phase to the molar fraction of the liquid phase in a situation of equilibrium for a given liquid.

Gels, widely used in cosmetics and in the food or petroleum industries, are generally dilute solutions of polymers, proteins, inorganic substances such as silica or clay in water or organic liquids. Gelling agents are necessary to the formation and maintenance of these gels.

Recently, there has been increasing interest in low-molecular-weight organogelators. This situation is motivated by the many potential applications of organogels obtained from these particular gelling agents as well as the fact that these systems have interesting self-assembly properties. In these organogels, as for other gelled systems, the gelling agent forms a continuous three-dimensional network that immobilizes the liquid and keeps it from flowing. Unlike their polymeric or inorganic analogs, the network architecture results from self-assembly of low-molecular weight organogelators by non-covalent forces, such as hydrogen bonds, Van Der Walls forces or even donor-acceptor interactions. Generally, the three-dimensional network consists of an assembly of organogelator molecules into interconnected fibrils or crystallites.

In the cosmetic, pharmaceutical or food fields, organogels have the advantage of being able to contain active ingredients or substances to facilitate the introduction and stability of said active ingredients or substances in compositions.

More particularly in the cosmetic field, many solutions have been considered to introduce, protect and even vectorize certain ingredients when their stability could be jeopardized by the formulation medium or manufacturing process or when it is preferable for the active ingredient to only be released at a given location. The penetration of active substances through the various layers of the skin can also be improved.

In the specific cases of gelling volatile organic liquids, such as, for example, essential oils or hydrocarbons, it was observed that gelling alone does not always permit reducing or controlling their volatilization, due to the fact that an organogel type composition of a volatile organic liquid can sometimes lose nearly all of the organic liquid by volatilization in a few hours.

Many industries use volatile organic liquids, including the cosmetic, perfume, plant health or pharmaceutical industries, as well as, obviously, the hydrocarbon industry, for example.

Essential oils (EO) are obtained by various extraction methods from a botanically defined plant material. Essential oils are complex mixtures comprising the fragrant and volatile components of a plant.

In particular, due to their antibacterial properties, essential oils have many applications in human or veterinary medicine, in the plant health field for dealing with biotic stress in crops, for example, in cosmetics, perfumery or agribusiness. However, due to their very marked and difficultly controllable volatility, their large scale use is limited. For certain fields of application, this high volatility of essential oils poses a problem. They volatilize quickly and therefore have a reduced activity over time.

In the field of flavors and fragrances, controlling the volatility of the fragrance, deodorant and odiferous mixtures, in general made up of volatile organic liquids, can be done by inclusion or encapsulation in a neutral matrix permitting slowed release. Such an encapsulation is technologically complex, however, often too sequestering and expensive.

In the field of organic control of plant health, the use of insect pheromones or essential oils is under development and is an ecological alternative for controlling insect pests. However, the formulation of these compounds generally in the form of highly volatile lipophilic organic liquids is difficult since their diffusion must be well monitored and controlled in order to obtain the effect sought.

Solutions seeking to limit the volatility of the organic liquids such as, in particular, essential oils, for example, exist and consist of the encapsulation thereof in a protein or polysaccharide polymer matrix. However, such solutions are very complex and difficult to implement, and especially do not permit tailored control and modulation of volatilization.

This is why there appears to be a need to limit and control the volatility of organic liquids, for example essential oils, in order to keep them from evaporating too quickly or in an undesired way or even to be able to intentionally modulate this volatility and their evaporation according to the applications considered.

The Applicant has shown that it was possible to limit and control the volatility and evaporation of organic liquids or solvents by gelling them and mixing them with terpene resins, in particular resin acid or terpenic acid compounds

The inventors have actually demonstrated that the addition of a small proportion by mass of natural resins to a gelled volatile organic solvent or liquid reduces its evaporation at room temperature.

It has also been demonstrated that there was additionally a synergy effect with the formation of an organogel. I.e., an organic liquid gelled by an organogelator combined with the addition of resin greatly reduces the volatility of the organic liquid. This technology permits reducing and especially controlling the volatilization of an organic liquid, such as an essential oil, for example, at a given temperature by modulating the gelling agent/resin compound proportions.

When organic liquids are gelled in the form of an organogel-type composition, the presence of terpene resin compounds, in particular resin acid or terpenic acid compounds—in addition to the ease of handling conferred by the solidification of said organic liquids—permits limiting and controlling the volatility of these organic liquids.

This is why a first purpose of the present invention is to provide a composition in the form of an organogel of an organic liquid comprising at least one resin acid.

The resin acid may be in the acid form or in the esterified form.

In a second embodiment, the organogel is composed of an organic liquid, comprising or consisting of a volatile organic liquid, and an organogelator.

According to a third embodiment, the organic liquid, comprising or consisting of a volatile organic liquid, is chosen from among the group made up of essential oils, organic solvents, pheromones with fatty chains, hydrocarbons and mixtures thereof.

Preferentially, the organic liquid, is a volatile organic liquid and is chosen from among the group made up of essential oils, volatile liquid organic solvents, pheromones with fatty chains, hydrocarbons and mixtures thereof.

According to a fourth embodiment, the organic liquid is a volatile organic liquid and is chosen from among the group made up of a eucalyptus essential oil, lavender essential oil, thyme essential oil, lemongrass essential oil, peppermint essential oil, sage essential oil and mixtures thereof.

According to a fifth embodiment, the organic liquid comprises a volatile organic liquid as defined above and a nonvolatile organic liquid chosen from the group of vegetable oils, mineral oils, oils of cosmetic interest (emollient) and mixtures thereof.

In the sense of the present invention, the term “volatile” concerning the organic liquid means a liquid whose saturation vapor pressure at 20° C. is greater than 0.01 mmHg, preferentially it is comprised between 0.01 and 20, preferably between 0.01 and 10, more preferably between 0.01 and 5 (in mmHg at 20° C.).

The concept of volatility relies on a precise definition, which is the saturation vapor pressure. This is the pressure at which the gas phase of a substance is equilibrium with its liquid or solid phase, at a given temperature, in a closed system. The saturation vapor pressure is related to the tendency of molecules to go from the liquid (or solid) state to the gaseous state. For information purposes, the saturation vapor pressure of water at 20° C. is 17.5 mmHg; that of butane is 1650 mmHg, that of propanol is 18 mmHg.

Vegetable oils are preferably chosen from among sunflower oil, canola oil, soybean oil and mixtures thereof.

According to a sixth embodiment of the invention, the organogelator is chosen from among the group made up of vegetable waxes, animal waxes, paraffin waxes, fatty acid derivatives, fatty acid salt derivatives, and more particularly 12-hydroxystearic acid, used alone or in mixture.

According to another particular embodiment, the composition according to the present invention is not an adhesive composition.

Thus, the present invention relates to compositions according to the different embodiments described here except for adhesive compositions.

According to a seventh embodiment, the quantity by mass of organogelator in the organogel is comprised between 1 and 30%; more particularly between 2 and 20%, more particularly still between 10 and 15%. The mass proportion of organogelator controls hardness, thermal resistance and, along with resin acid, the volatilization of the gelled liquid.

In one particular embodiment, the plant or animal wax is chosen from among the group consisting of candelilla wax, carnauba wax, sunflower seed wax, beeswax, rice bran wax, sugar cane wax, grape seed wax, jojoba wax, sorghum seed wax, ouricury wax, pea leaf wax, potato leaf wax, esparto wax, ocotillo wax, Balanophora wax, Annona squamosa wax, sea rye wax, cherry laurel wax, oak wax, mimosa wax, orange blossom wax, jasmine wax, rose wax, hemp wax, apricot wax, tuberose wax, orange wax, sweet almond wax, pine needle wax. The vegetable wax may be a wax from the aerial parts, leaves, stems, flowers or roots of the plant.

Candelilla wax is particularly suited because it is well known. Candelilla wax is obtained from a shrub called Euphorbia antisyphilitica originally from northern Mexico. This natural hard wax is mainly used by the cosmetic and pharmaceutical industries for making sticks. It is also used in agribusiness. It is composed mainly of hydrocarbons (approximately 45%), fatty acids (approximately 20%), fatty alcohols, fatty acid esters and also comprises resins (approximately 5% each). Natural candelilla wax comprises at least one triterpenic resin acid or an ester of such a triterpenic resin acid. Natural candelilla wax may comprise one or more diterpenic resin acids.

The resins present in candelilla wax comprise triterpenic acid esters (oleanic, ursolic, oleanonic, ursonic and moronic).

Synthetic candelilla wax or substitute candelilla wax is available on the market, which comprises a paraffin, carnauba wax and terpenoids. Candelilla Wax Substitute 6700 can be particularly mentioned, comprising Copernicia cerifera wax, Helianthus annuus wax, Polyethylene, C30-C50 alcohols,

Montanic acid wax, Shorea robusta resin, Hydrogenated Styrene Copolymer/Ethyl Styrene/hydrogenated Indene

Carnauba wax is also well suited. It is a vegetable wax that comes from a palm tree native to from Brazil, Copernicia cerifera. This wax is very often used in industry, due to its high melting point among the vegetable waxes marketed.

It has good emulsifying properties and a good capacity to bond with oils and thereby increase the melting point during formation of gels with oil. It is composed mainly of fatty acid esters (approximately 80%), fatty alcohols (approximately 15%), fatty acids and hydrocarbons, (approximately 5%).

Another suitable vegetable wax, whose composition is close to that of carnauba, is sunflower wax, which is obtained from sunflower oil by cold filtration.

Particularly, the wax is candelilla wax.

According to one embodiment of the invention, the resin acid is chosen in the group made up of diterpenic acids.

According to one embodiment of the invention, the resin acid is chosen in the group made up of triterpenic acids, triterpenic acid esters and mixtures thereof. The triterpenic acid esters can be an oleanic acid ester, an ursolic acid ester, an oleanonic acid ester, an ursonic acid ester or a moronic acid ester.

According to one embodiment of the invention, the resin acid is chosen from among the group made up of triterpenic acids, triterpenic acid esters, diterpenic acids and mixtures thereof.

According to an eighth embodiment of the invention, the resin acid is chosen in the group made up of abietic resin acids.

According to another embodiment of the invention, the abietic resin acids are chosen from among the group consisting of abietic acid, neoabietic acid, dehydroabietic acid, palustric acid, and mixtures thereof.

According to another embodiment of the invention, the resin acid is in the form of a plant resin or a mixture of plant resins.

Plant resins are substances naturally secreted by certain plants.

The term resinous is often used to designate conifers. There are many plants other than conifers that secrete resins.

Resins are excreted from plant cells. They are differentiated from latexes which are kept within the cell walls.

Resinous conifers produce rosin. Rosin contains resin acids whose nature and proportions vary according to the species.

Rosin is 90% composed of a mixture of organic acids of the diterpene family, called resin acids.

According to another embodiment of the invention, the plant resin is chosen from among the group made up of pine resin, rosin, Sondarac resin, Dammar resin, mastic gum and mixtures thereof.

According to another embodiment of the invention, the quantity of resin acid by mass in the organogel is comprised between 0.5 and 10%.

A resin acid is a nonvolatile terpenic acid present in plant resins and more particularly in that of pines. They are wood protectors and preservatives that are produced by parenchymal epithelial cells that surround the resin canals in temperate conifer forests.

Chemically, resin acids are formed by combinations of molecules with two or three carbons with isoprene units to form mono, sesquiterpene, diterpene or even triterpene structures). Resin acids have two functional groups, one carboxyl group and double bonds.

Resin acids according to the invention may be chosen from among the group consisting of diterpenic acids and triterpenic acids alone or in mixtures as well as their esters.

It is noteworthy that when the organogelator is a vegetable wax, in particular waxes obtained by extraction via immersion in a mixture of boiling water and acid, and more or less artisanally, it is common for it to contain traces of natural plant resins containing resin acids and it should be taken into account in the quantity of total resin acid in the organogel.

Thus, the quantity of resin acid added into the organogel may be modulated as a function of the quantity already present, if applicable, in the organogelator, in particular a wax when it is used as an organogelator.

Therefore, when a resin acid is naturally present in the organogelator (for example for candelilla wax), no supplemental addition of resin acid is necessary. It is therefore important to take into account only the amount of resin acid present in the organogel formed by the gelling of the organic liquid, comprising or consisting of a volatile organic liquid.

Another purpose of the present invention is to provide for the use of an organogel composition according to the present invention to reduce the volatility of the organic liquid, comprising or consisting of a volatile organic liquid, contained in the organogel.

In one particular embodiment of the invention, the use according to the present invention relates to the use of a composition in the form of organogel in which the organic liquid, comprises or consists of a hydrocarbon in order to limit the risks of inflammation and/or explosion.

The present invention also relates to the use of a composition according to the invention in which the gelled organic liquid comprises or consists of at least one volatile essential oil or a mixture of essential oils for the controlled diffusion of this oil or this mixture.

It is also a purpose of the present invention that relates to the use of a composition according to the invention in which the organic liquid, comprising or consisting of a volatile organic liquid, is a pheromone, in particular a fatty chain pheromone or a mixture of pheromones, in particular fatty chain pheromones, for the controlled diffusion of this pheromone or this mixture of pheromones.

The present invention also relates to the use of a composition according to the invention in which the organic liquid, comprising or consisting of a volatile organic liquid, comprises a fragrance for the controlled diffusion of this fragrance.

The present invention also relates to the use of a composition according to the invention in which the organic liquid, comprising or consisting of a volatile organic liquid, is chosen in the group of liquid insecticides or insect repellents, anti-fungal, anti-viral or anti-bacterial agents for the controlled diffusion of this organic liquid.

The invention also relates to an insecticide or insect repellent formulation in which the organic liquid, comprising or consisting of a volatile organic liquid, is endowed with insecticidal or insect repellent properties.

The invention also relates to an antibacterial formulation comprising a composition according to the invention, in which the organic liquid, comprising or consisting of a volatile organic liquid, is endowed with antibacterial properties.

The invention also relates to an antiviral formulation comprising a composition according to the invention, in which the organic liquid, comprising or consisting of a volatile organic liquid, is endowed with antiviral properties.

The compositions according to the invention may have a consistency ranging from a very viscous liquid to a compact solid as a function of the proportion of organogelator in the organogel.

In one advantageous aspect, the proportion of organogelator is comprised between 1% and 30% by mass relative to the total mass of the organogel.

According to the invention, the low-molecular-weight organogelator is a small organic molecule able to gel a large range of organic liquids in small proportions. Low molecular weight in the sense of the present invention means a molecular weight less than 1000 g/mol, and more particularly less than 500 g/mol.

In one advantageous aspect of the invention, the organogelator will be chosen from among vegetable waxes and mixtures thereof.

The organogelator may be chosen in the group made up of vegetable waxes, animal waxes, paraffin waxes, fatty acid esters, fatty acids and their derivatives or monovalent, divalent or trivalent metal salts, and more particularly 12-hydroxystearic acid, used alone or in mixture.

Animal and vegetable waxes are generally mixtures of fatty acid esters, fatty acids, fatty alcohols, very long chain fatty acids and hydrocarbons (>30).

According to the present invention, the organogelator is preferentially chosen from among optionally substituted fatty acid derivatives as well as their monovalent metal salts or their esters.

A particularly suitable organogelator for the implementation of the present invention is 12-hydroxystearic acid.

A particularly suitable organogelator for the implementation of the present invention is carnauba wax.

A particularly suitable organogelator for the implementation of the present invention is candelilla wax.

The gelling process consists of forming a gel from a liquid. In one particular case according to the invention, the organic liquid to be gelled is an oil or mixture of oils comprising or consisting of a volatile oil or a mixture of volatile oils.

The gelling agent, called organogelator, is capable of self-organizing to form filaments or crystallites. These fibers or crystallites intertwine or interconnect to form a three-dimensional organization. This network traps the organic liquid and prevents it from flowing. From the macroscopic viewpoint, the liquid has become “solid”. Gelling is a reversible means of creating a material from a liquid, but not changing its chemical composition. The self-organization of the organogelator consists of noncovalent interactions such as hydrogen bonds, π-π complexes or van der Waals forces.

Organogelators are able to gel any sort of organic liquid even at relatively low weight concentrations (typically a few percents by weight). 12-hydroxyoctadecanoic (or 12-hydroxystearic acid, HSA) is an organogelator that gels by forming a 3D network of intertwined fibers. Carnauba (car) and candelilla (can) waxes are also organogelators, but which gel by forming an interconnected crystallite network.

In the context of the present invention, the organic liquid, comprising or consisting of one or more volatile organic liquids, able to be gelled in the form of an organogel is liquid at ambient temperature, i.e., 25° C. and under atmospheric pressure of 1 atm.

They have a lipophilic nature. Thus, and in a non-exhaustive manner, vegetable oils, mineral oils, emollient oils, silicone oils, fluorinated oils, essential oils, fatty-chain pheromones, hydrocarbons, perfumes can be mentioned, as well as any volatile or nonvolatile active ingredient or substance, liquid at room temperature and atmospheric pressure, as well as all combinations of these organic liquids.

According to the invention, the organogel is held by the formation of a three-dimensional network made up of an assembly of organogelator molecules into fibrils that self-assemble into interlaced fibers and bundles of fibers or crystallites that immobilize the organic liquid within the network forming said organogel obtained.

Stabilization of the gelled organic liquid is thus assured.

The present invention also concerns a preparation method for a composition in the form of an organogel comprising the steps of:
(a) Preparation of a mixture comprising an organogelator, an organic liquid, comprising or consisting of a volatile organic liquid, and liquid at room temperature, and at least one resin acid.
(b) heating in order to solubilize all the ingredients,
(c) cooling of the mixture to room temperature in order to form an organogel.

The organogel is thus prepared by mixing the gelling agent with a volatile organic liquid, comprising or consisting of a volatile organic liquid, and at least one resin acid until a liquid solution (“sol”) is obtained.

In one particular embodiment of the invention, step (a) of preparing the mixture is done with an organogelator naturally comprising a resin acid (for example candelilla wax). In such an embodiment, this step consists of preparing a mixture comprising an organogelator comprising at least one resin acid, with an organic liquid, comprising or consisting of a volatile organic liquid, and liquid at room temperature. According to another embodiment of the invention, step (a) consists of preparing a mixture comprising an organogelator comprising at least one resin acid, with an organic liquid, comprising or consisting of a volatile organic liquid, and liquid at room temperature, and at least one additional resin acid not naturally present in the organogelator.

When the solution cools, it forms a gel from a certain temperature that sets the organic liquid. This temperature is the sol-gel transition temperature (Tgel) which is a physical characteristic of the organogelator/organic liquid pair.

In one advantageous aspect of the invention, step a) is done at a temperature comprised between 30 and 50° C. Care is taken to control this temperature in order to prevent evaporation of the organic liquid that can comprise or consist of a volatile organic liquid in order to prevent evaporation during production of the organogel.

The resin/gelation synergy allows a controlled reduction of volatility, while solidifying the liquid, which allows better handling and better storage. This gelled form opens up new prospects in numerous fields (health, plant health, cosmetics).

The invention also permits controlling the volatilization of a volatile hydrocarbon (e.g. kerosene) which limits the risks of inflammation or explosion during its transport or storage without affecting its thermal properties

Organogel compositions according to the present invention are designed to be used for the preparation of compositions whose utility depends on the nature and properties of the organic liquid comprising or consisting of a volatile organic liquid, more particularly when the organic liquid is a volatile organic liquid or a mixture of volatile organic liquids.

It was also noted that the gelation of an organic liquid comprising or consisting of a volatile organic liquid, by paraffin wax or paraffin as organogelator limits the volatility and evaporation of said volatile organic liquid without the addition of resin or resin acid.

It is thus another purpose of the present description to provide a composition in the form of an organogel of an organic liquid and paraffin.

The organogel is made up of an organic liquid, comprising or consisting of a volatile organic liquid and a paraffin, or mixture of paraffins, as the organogelator.

The organic liquid, comprising or consisting of a volatile organic liquid, may be chosen from among the group made up of essential oils, organic solvents, pheromones with fatty chains, hydrocarbons, vegetable oils and mixtures thereof.

Paraffin is a mixture of linear or branched long-chain alkanes. We talk about paraffins rather than paraffin in the individual sense because several types of paraffins exist.

The paraffin usable in the context of the present invention, permitting gelling and reducing the volatility of an organic liquid, comprising or consisting of a volatile organic liquid, and without introduction of resins and resin derivatives, is preferentially chosen in the group made up of paraffins essentially made up of C20 to C40 linear alkanes (n-alkanes) with a melting point comprised between 50 and 65° C. They are paraffins solid at room temperature, i.e., 20° C.

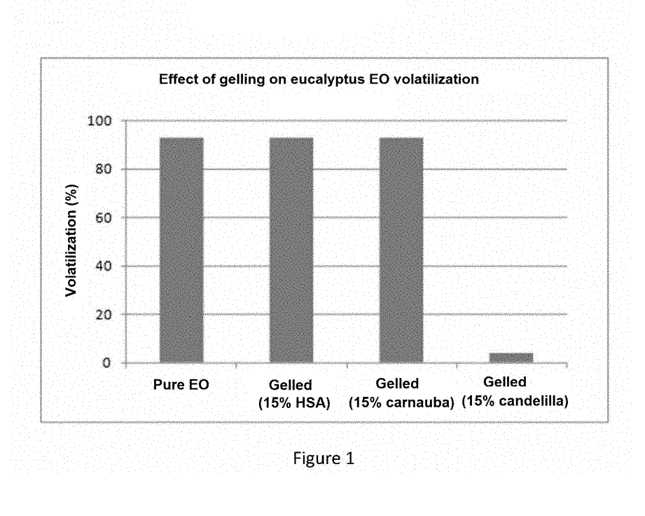

FIG. 1: Residue at 5 hours after a TGA experiment at 30° C. of the effect of gelation of a eucalyptus essential oil.

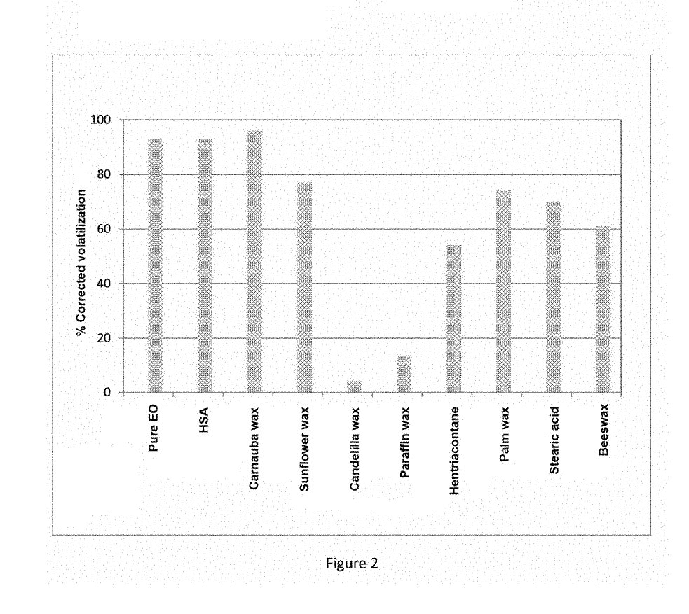

FIG. 2: Effect of gelation on the volatilization of an EO. Eucalyptus (15% by mass organogelator).

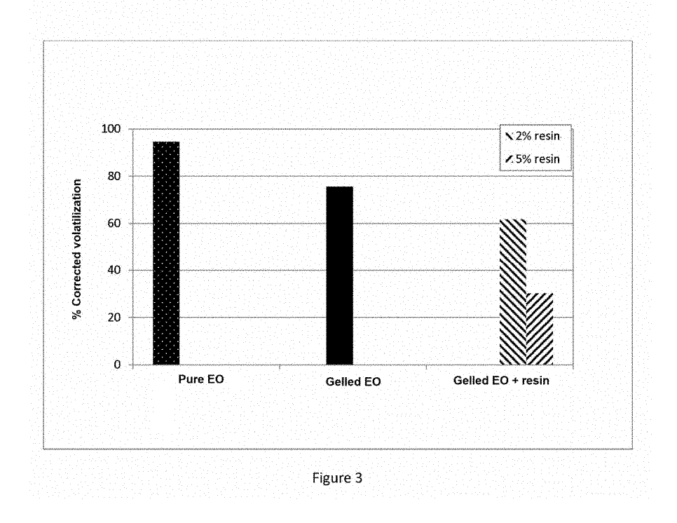

FIG. 3: effect of the addition of rosin (2 or 5%) on eucalyptus EO gelled by carnauba wax (15% by mass)

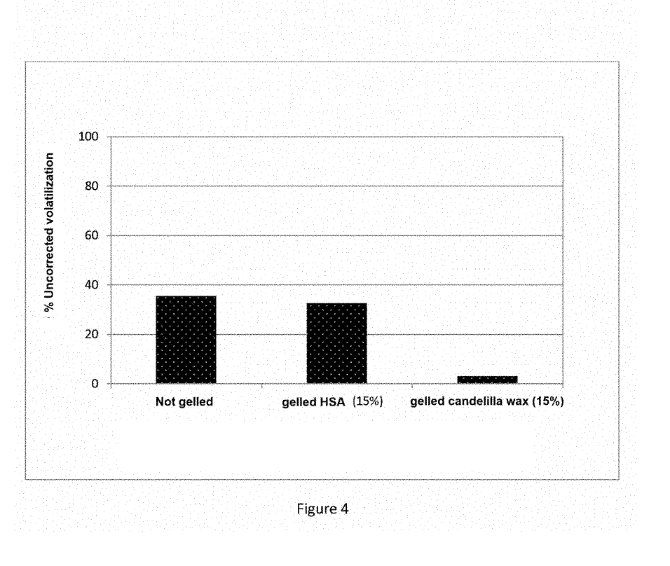

FIG. 4: Effect of gelling (15% HSA or candelilla wax) on a soybean oil/EO mixture. eucalyptus (50-50%).

### EXAMPLES

### Preparation of the Organogel.

Fixed concentrations of gels are obtained by adding weighed quantities of organogelator (vegetable wax and/or 12-hydroxystearic acid) with the optional addition of resin acids in the form of plant resin or pure resin acids, to different eucalyptus, thyme or lavender essential oils. The mixture is heated to a temperature above the gel point, generally around 23 to 40° C. This temperature varies according to the nature and quantity of ingredients of the organogel. The solution is cooled to room temperature and a gel is obtained. The state of the gel is confirmed by the inverted vial test.

Table 1 summarizes the preparation conditions of the various organogels.

TABLE 1

| | | | Tdegel | ΔHdegel | Tgel | ΔHgel |
|---|---|---|---|---|---|---|
| Code | Volatile compound | Organogelator | (° C.) | J g⁻¹ | (° C.) | J g⁻¹ |
| AH61 | Eucalyptus EO | 7% HSA | 23 | 1.9 | 23.8 | 1.3 |
| AH61 | Eucalyptus EO | 15% HSA | 37.5 | 7.7 | 41.6 | 3.6 |
| AH61 | Thyme EO | 15% car | Not visible | | 35.9 | 2 |
| AH61 | Thyme EO | 15% HSA | Several max at | | 2 max at | |
| | | | 31; 37.5 and | | 27.47 | |
| | | | 52° C. | | | |
| AH61 | Lavender EO | 15% car | Not visible | | 2 max at | |
| | | | | | 37.51.4 | |
| AH61 | Lavender EO | 15% HSA | 33.6 | 9.8 | 2 close | 8.4 |
| | | | | | max 39.5 | |
| AH67 | Eucalyptol | 15% HSA | 26.4 | 3.3 | 27.2 | 2.2 |
| AH67 | | Hent | 30.2 | 2.6 | 36.2 | 4 |
| AH67 | | 15% can | 28 | 2.5 | 33.4 | 3.3 |
| AH67 | Thyme EO | 15% can | No signal | | | |
| AH67 | Lavender EO | 15% can | No signal | | | |
| LL06 | Eucalyptus EO | 15% hent | 27.4 | 3.8 | 2 close | 4.1 |
| | | 2% rosin | | | max 33.1 | |
| LL06 | Eucalyptus EO | 2% rosin | | | | |
| LL06 | Eucalyptus EO | | | | | |
| LL06 | Eucalyptus EO | 15% HSA | 29.8 | 2.6 | 26.8 | 1.7 |
| | | 2% rosin | | | | |
| LL06 | Eucalyptus EO | 15% can | 31 | 5 | 32.8 | 1.8 |
| LL06 | Eucalyptus EO | 15% car | No signal | | 2 max at | 1.8 |
| | | | | | 34.1 | 0.7 |
| | | | | | 26.2 | |
| AH89 | Eucalyptus EO | 15% hent | 30.8 | 1.8 | Broad | 2 |
| | | 2% Abietic | | | signal | |
| | | acid | | | 32.6 | |

Hent: Hentriacontane
Car: Carnauba wax
Can: Candelilla wax

Other organogels have been prepared in a similar manner with mixtures of essential oil and soybean oil and/or by using other organogelators such as steric acid, sodium stearate, sunflower oil, paraffin wax, pine needle wax or beeswax.

The gelling agent called organogelator is capable of self-organizing to form filaments or crystallites. These fibers or crystallites intertwine or interconnect to form a three-dimensional organization. This network traps the organic liquid and prevents it from flowing. From the macroscopic viewpoint, the liquid has become “solid”. Gelling is a reversible means of creating a material from a liquid, but not changing its chemical composition. The self-organization of the organogelator consists of noncovalent interactions such as hydrogen bonds or van der Waals forces.

Organogelators are able to gel any sort of organic liquid even at relatively low weight concentrations (typically a few percents by weight). 12-hydroxyoctadecanoic (or 12-hydroxystearic acid, HSA) is an organogelator that gels by forming a 3D network of intertwined fibers. Waxes, such as carnauba (car) and candelilla (can) waxes are also organogelators, but which gel by forming an interconnected crystallite network.

Different essential oils were gelled by three organogelators. The gel points were determined. The volatilization of pure or gelled essential oils was measured by thermogravimetric analysis (TGA) at a fixed temperature. The three essential oils tested were eucalyptus (Eucalyptus globulus, Phytosun aroms®), lavender (Lavandula officinalis, Phytosun aroms®) and thyme (Thymus vulgaris, Phytosun aroms®). The case where an essential oil is diluted/dissolved in a nonvolatile organic liquid was also tested: glyceryl trioctanoate or soybean oil were chosen.

The organogelators tested are 12-hydroxystearic acid and vegetable waxes, in particular carnauba and candelilla wax. These two vegetable waxes are used in the cosmetic and agribusiness industries. These vegetable waxes are complex mixtures of natural compounds. Carnauba wax contains mainly fatty acid esters (80-85%), fatty alcohols (10-15%) acids (3-6%) and hydrocarbon chains (1-3%). A particular feature of carnauba wax is the presence of a large amount of diol esters (around 20%), hydroxylated fatty acids (around 6%) and cinnamic acid (around 10%) which is an antioxidant. Carnauba wax has a melting point of 78 to 85° C., which is one of the highest of the waxes of natural origin. Candelilla wax is made up of hydrocarbons (approximately 50%, with a chain length of 29 to 33 carbon atoms), esters, free fatty acid alcohols and resins. Its melting point is 68 to 70° C. The main compound of candelilla wax is a linear alkane with 31 carbon atoms, hentriacontane (hent); this pure compound is also tested as an organogelator.

### Measuring Volatilization by Thermogravimetric Analysis TGA.

A sample of known mass is placed in a crucible under controlled atmosphere and controlled temperature. The variation of the sample mass is measured over 5 hours. The mass of the residue is expressed in percentage of the initial mass. The experiments are conducted at 30 or 40° C. This mass measurement is precise, we believe the experimental error here to be 3%.

### Results

After 5 hours of experimentation the eucalyptus essential oil residue is 7% by mass; 93% of the oil has volatilized. The lavender and thyme essential oils are less volatile at 30° C. since the residues after 5 hours are 53 and 54%, respectively.

When the essential oil is gelled, we need to do a correction relative to the raw results. We consider the organogelator not to be volatile. To express the proportion of essential oil volatilized relative to the quantity initially introduced, it is necessary to subtract the mass of the organogelator. In FIG. 2, the eucalyptus essential oil is gelled with 15% by mass of HSA; it is volatilized to 79% after 5 hours. If the correction is made, the volatilization rate of the essential oil is calculated at 93%. This value may then be compared to the pure essential oil experiment; in the rest of this disclosure, only the corrected values will be reported. Note that the HSA-based organogel does not change the volatilization properties of the eucalyptus essential oil: 93% volatilization, whether gelled or not. Also, carnauba wax does not reduce the volatilization of eucalyptus essential oil. On the contrary, candelilla wax has a very pronounced effect since no more than 4% of the oil is volatilized. In summary, while nearly all of the eucalyptus essential oil is volatilized after 5 hours at 30° C., once gelled by the candelilla wax, it practically no longer volatilizes.

The mass percent of candelilla wax used to gel eucalyptus EO has an impact on the gel volatilization. By increasing the percentage of organogelator, the volatilization of the EO is further delayed.

Two other essential oils (lavender and thyme) were gelled by candelilla wax and tested by TGA.

Lavender essential oil volatizes to 37% after 5 hours at 30° C. Once gelled with candelilla wax, it only volatizes to 5% under the same conditions. In the case of thyme essential oil, which volatilizes to 43% after 5 hours at 30° C., gelation by candelilla wax reduces these losses to 8%.

These first volatilization measures have clearly shown that gelling alone does not noticeably reduce the volatility of an essential oil. This singular result obtained during gelling by candelilla wax may initially be explained by its composition.

Carnauba wax is extracted mechanically from the leaves of a Brazilian wax palm, and HSA a purified synthetic product. In contrast, candelilla wax is obtained artisinally, from a Mexican spurge (Euphorbia antisyphilitica) by a collection of chemical extraction processes. As a result, this wax contains resin residues (around 2% by mass) in addition to cuticular waxes; they are resin acids such as abietic acid.

The influence of natural resins on the volatility of an essential oil and synergy with organogelation:

The particularly noteworthy effect of gelling with candelilla wax led to testing the effect of natural resins on reducing volatility. In a first step, crude pine resin (Pinus pinaster), rosin which is the solid resin obtained after distillation of terebenthene), and abietic acid, which is a triterpenoid, the primary component of rosin, were used.

Gelling by hentriacontane (primary constituent of candelilla wax) or HSA alone did not reduce EO volatilization (93%). A substantial synergy effect of resin is observed when the EO is gelled with hentriacontane (15% by mass) since the volatilization rate is comprised between 27 and 12% depending on the resin tested. In the case of gelling with HSA, the effect is less marked with a volatilization of 78% with rosin.

In the case of gelling of eucalyptus EO by HSA (15% by mass), the quantity of resin added was tested. Note that the volatilization of EO may be reduced by increasing the amount of resin. In this case, a rate of 2 to 8% reduces volatilization from 78 to 56%.

All of these results underline the benefit of the invention in the field of controlling the volatility of essential oils or organic liquids. Reducing this latter by adding natural resins, gelling by candelilla wax or the addition of organogel resins allows extending the use of essential oils and reducing the inflammability of certain organic liquids (e.g. kerosene).

1- Composition in the form of an organogel of an organic liquid comprising at least one resin acid.

2- Composition according to claim 1, characterized in that the organogel is composed of an organic liquid, comprising or consisting in a volatile organic liquid and an organogelator.

3- Composition according to claim 1 or 2, characterized in that the organic liquid, comprising or consisting of a volatile organic liquid, is chosen from among the group made up of essential oils, organic solvents, pheromones with fatty chains, hydrocarbons and mixtures thereof.

4- Composition according to claim 1 or 2, characterized in that the organic liquid is a volatile organic liquid and is chosen from among the group made up of essential oils, volatile organic solvents, pheromones with fatty chains, hydrocarbons and mixtures thereof.

5- Composition according any one of claims 1 to 3, characterized in that the organic liquid comprises a volatile organic liquid and a nonvolatile organic liquid chosen from the group of vegetable oils, mineral oils, oils of cosmetic interest and mixtures thereof.

6- Composition according to any one of claims 1 to 5, characterized in that the organogelator is chosen from among the group made up of vegetable waxes, animal waxes, paraffin waxes, fatty acid derivatives, fatty acid salt derivatives, and more particularly 12-hydroxystearic acid, used alone or in mixture.

7- Composition according to claim 6, characterized in that the vegetable or animal wax is chosen from among the group consisting of candelilla wax, carnauba wax, sunflower seed wax, beeswax, rice bran wax sugar cane wax, grape seed wax, jojoba wax, sorghum seed wax, ouricury wax, pea leaf wax, potato leaf wax, esparto wax, ocotillo wax, Balanophora wax, Annona squamosa wax, sea rye wax, cherry laurel wax, oak wax, mimosa wax, orange blossom wax, jasmine wax, rose wax, hemp wax, apricot wax, tuberose wax, orange wax, sweet almond wax or pine needle wax.

8- Composition according to any one of claims 1 to 7, characterized in that the quantity by weight of organogelator in the organogel is comprised between 1 and 30%.

9- Composition according to any one of the preceding claims, characterized in that the resin acid is chosen from among the group made up of abietic resin acids.

10- Composition according to claim 9, further characterized in that the abietic resin acids are chosen from among the group made up of abietic acid, neoabietic acid, dehydroabietic acid, palustric acid and mixtures thereof.

11- Composition according to any one of the preceding claims, characterized in that the resin acid is in the form of a plant resin or a mixture of plant resins.

12- Composition according to claim 11, characterized in that the plant resin is chosen from among the group made up of pine resin, rosin, Sondarac resin, Dammar resin, mastic gum and mixtures thereof.

13- Composition according to any one of the preceding claims, characterized in that the quantity by weight of resin acid in the organogel is comprised between 0.5 and 10%.

14- Use of a composition according to any one of the preceding claims to reduce the volatility of the organic liquid, comprising or consisting of a volatile organic liquid, contained in the organogel.

15- Use according to claim 14 in which the organic liquid, comprising or consisting of a volatile organic liquid, is an inflammable hydrocarbon in order to limit the risks of explosion.

16- Use according to claim 14, in which the organic liquid, comprising or consisting of a volatile organic liquid, is a pheromone, in particular a fatty chain pheromone or a mixture of pheromones, in particular fatty chain pheromones, for the controlled diffusion of this pheromone or this mixture of pheromones.

17- Use according to claim 14, in which the organic liquid, comprising or consisting of a volatile organic liquid, is chosen in the group of liquid insecticides or insect repellents, anti-fungal, anti-viral or anti-bacterial agents for the controlled diffusion of this organic liquid.

18- Insecticide or insect repellent formulation comprising a composition according to one of claims 1 to 13, in which the organic liquid, comprising or consisting of a volatile organic liquid, is endowed with insecticidal or insect repellent properties.

19- Antibacterial formulation comprising a composition according to one of claims 1 to 13, in which the organic liquid, comprising or consisting of a volatile organic liquid, is endowed with antibacterial properties.

20- Antiviral formulation comprising a composition according to one of claims 1 to 13, in which the organic liquid, comprising or consisting of a volatile organic liquid, is endowed with antiviral properties.

21- Preparation method for a composition according to one of claims 1 to 13 comprising the steps of:
a) Preparation of a mixture comprising an organogelator, an organic liquid, comprising or consisting of a volatile organic liquid, and liquid at room temperature, and at least one resin acid.
b) heating in order to solubilize all the ingredients,
c) cooling of the mixture to room temperature in order to form an organogel.
